(19) United States
(12) Patent Application Publication
(10) Pub. No.: US 2017/0286684 A1
(43) Pub. Date: Oct. 5, 2017

(54) Method for Identifying and Removing Malicious Software

(71) Applicant: BeeStripe LLC, Honolulu, HI (US)

(72) Inventors: Aaron Ford Lovelace, Honolulu, HI (US); Ciaran Seoirse Thompson, Honolulu, HI (US); Steven Michael Markowitz, Honolulu, HI (US)

(21) Appl. No.: 15/625,772

(22) Filed: Jun. 16, 2017

Related U.S. Application Data
(63) Continuation-in-part of application No. 14/725,593, filed on May 29, 2015.
Application No. 14/725,593 is a continuation-in-part of application No. PCT/IB2017/005360, filed on Jun. 16, 2017.
(60) Provisional application No. 62/350,963, filed on Jun. 16, 2016.
(60) Provisional application No. 62/005,739, filed on May 30, 2014.
(60) Provisional application No. 62/350,963, filed on Jun. 16, 2016.

(51) Int. Cl. G06F 21/56; G06F 21/53; G06F 21/57

(52) U.S. Cl. CPC G06F 21/566; G06F 21/577; G06F 21/53; G06F 2221/033; G06Q 30/0269

(57) ABSTRACT

A method for identifying and removing malicious code uses a personal computing device that can communicate with a remote server. The remote server manages a blacklist and a whitelist. The blacklist is a list of programs that are known to contain malicious code. The whitelist is a list of programs that are known to be free of malicious code. The method begins when a scan request is received. The scan request is a command that directs the personal computing device to work with the remote server to perform a scan of a collection of files that will identify malicious code. The method then performs a sandboxed-evaluation process to identify files that are found to contain malicious code. The sandboxed-evaluation process is an isolated testing routine that runs program files to detect malicious code. Finally, the method executes a threat remediation process if malicious code is found.

The current application claims a priority to the U.S. Provisional Patent application Ser. No. 62/350,963 filed on Jun. 16, 2016.

### FIELD OF THE INVENTION

The present invention relates generally to a method of protecting a user's web browser from undesired add-ons and extensions. More specifically, the present invention identifies and disables malicious programs, files, and browser extensions.

### BACKGROUND OF THE INVENTION

Present day, when users install browser add-ons or extensions, hereafter referred to as “extensions,” this often results in certain settings being changed in a way that the user potentially did not want or expect. When settings such as the default search engine and new tab page are changed unexpectedly, it is very frustrating and degrades the overall experience of browsing the Internet for the user. Additionally, some browser extension developers purposefully include these unwanted settings changes, such as changing the default search provider, in their extensions. Moreover, these browser extensions can exhibit other malicious behaviors such as not functioning as advertised, tracking personal information, and installing malware on the user's computer.

It is therefore an objective of the present invention to introduce a method that users can utilize to overcome such problems. The present invention is a method which monitors and searches for any installation of extensions known to cause problems. For example, one possible scenario occurs when the user is surfing for movies and suddenly receives a popup that contains what looks like, but is not, a video download button. If the user clicks it, the user observes that there is now a toolbar on their browser which changed his/her search settings, etc. unexpectedly. The present invention is notable because it checks for such problems at the moment of installation. There are extensions out there that remove all extensions on the user's computer. However, this method is often considered excessive.

The present invention is a browser extension that resides on the user's PC and monitors other extensions. When an extension that exhibits unwanted/undesirable behavior is installed, it will be disabled and/or uninstalled by the monitoring extension.

In contrast to a delete-all, blanket approach often utilized by the prior art, the present invention instead checks the extensions against a database and removes the known bad actors. The present invention takes a list of all the browser extension IDs on the user's computer, and sends it over to the remote server. The server checks to see if any of those IDs are known bad actors. It will return the list of matches and dispose of them.

Alternatively, instead of disabling or uninstalling an undesired extension automatically, the present invention can prompt the user to remove or de-activate the offending extension manually. The monitoring extension performs this check for extensions that are potentially undesirable. Checks will occur periodically and at other certain points in the extension's lifecycle. This is a more customized solution, compared to the prior art. It is more surgical, and not a blanket solution prone to excess.

### BRIEF DESCRIPTION OF THE DRAWINGS

FIG. 1 is a block diagram illustrating the communication between the components of the system required to execute the method of the present invention.

FIG. 2 is a flowchart illustrating the overall method of the present invention.

FIG. 3 is a flowchart illustrating the sub-process for selecting one or more personal files to be scanned for malicious code using the present invention.

FIG. 4 is a flowchart illustrating the sub-process for scanning newly downloaded files using the present invention.

FIG. 5 is a flowchart illustrating the sub-process for initiating a periodic scan using the present invention.

FIG. 6 is a flowchart illustrating the sub-process for performing the sandboxed-evaluation process using the present invention.

FIG. 7 is a flowchart illustrating the sub-process for performing the threat remediation process using the present invention.

FIG. 8 is a flowchart illustrating the sub-process for selecting and executing a delete command for the threat remediation process using the present invention.

FIG. 9 is a flowchart illustrating the sub-process for selecting and executing a quarantine command for the threat remediation process using the present invention.

FIG. 10 is a flowchart illustrating the sub-process for distributing targeted advertisements using the present invention.

### DETAIL DESCRIPTIONS OF THE INVENTION

All illustrations of the drawings are for the purpose of describing selected versions of the present invention and are not intended to limit the scope of the present invention.

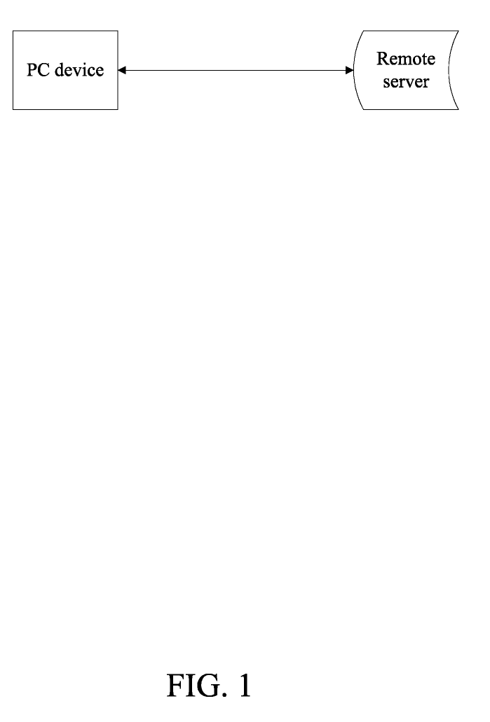

As can be seen in FIG. 1 through FIG. 10, the present invention, the method for identifying and removing malicious software, is a method for keeping a user's computing device free of malicious files including, but not limited to, documents, programs, and browser extensions. The present invention makes use of an automated scanning function and a manual scanning function to identify and disable malicious files on the user's computing device. The term malicious files is used herein to refer to malicious code or viruses. Specifically, the present invention can operate as a real-time scanning system that identifies malicious files as they are downloaded or installed onto the user's computing device. Additionally, the present invention can operate as a manual or periodic scanning system that either performs a scan when directed, or performs the scan on a fixed schedule. The scanning function of the present invention is designed to identify malicious files by comparing the files to a blacklist. Additionally, the present invention makes use of a sandboxing system that tests files to determine whether or not the files are malicious. Another aspect of the present invention recommends programs and services that the user may find useful.

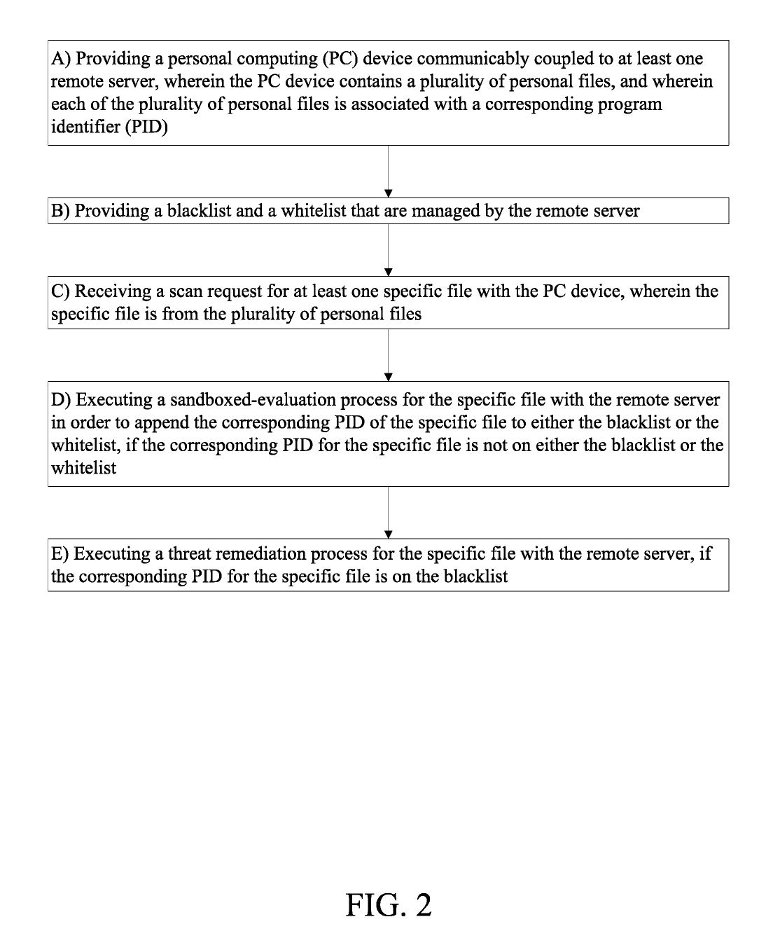

As can be seen in FIG. 2, to achieve the above described functionality, the overall method of the present invention makes use of a system that provides a personal computing (PC) device communicably coupled to at least one remote server (Step A). The PC devices used to interact with the present invention can be, but is not limited to, a smart-phone, a laptop, a desktop, or a tablet PC. The remote server is used to execute a number of internal processes for the present invention and to communicate malicious code information to the PC device. The PC device contains a plurality of personal files, each of which is associated with a corresponding program identifier (PID). The plurality of personal files is a collection of documents, programs, and program extensions that are stored on the user's PC device. Additionally, the PID is the identifier that the present invention uses to differentiate between each of the plurality of personal files. The overall method of the present invention also provides a blacklist and a whitelist that are managed by the remote server (Step B). The blacklist is a list of PIDs that are associated with personal files which are known to contain malicious code. Conversely, the whitelist is a list of PIDs that are associated with personal files which are known to be free of malicious code. The PC device, the remote server, the blacklist, and the whitelist are the elements of the system that are required to execute the method of the present invention.

As can be seen in FIG. 2, once the above described system elements are provided, the overall method of the present invention continues by receiving a scan request for at least one specific file with the PC device (Step C). The scan request is a command that directs the method of the present invention to initiate a malicious code scan of the PC device. The at least one specific file is the file that will be scanned for malicious code. Specifically, the at least one specific file is one or more personal files that the method of the present invention will scan for malicious code. The overall method of the present invention continues by executing a sandboxed-evaluation process for the specific file with the remote server in order to append the corresponding PID of the specific file to either the blacklist or the whitelist, if the corresponding PID for the specific file is not on either the blacklist or the whitelist (Step D). The sandboxed-evaluation process is a sub-process of the overall method of the present invention that determines if the specific file contains malicious code. If the specific file is determined to contain malicious code, then the corresponding PID is added to the blacklist. Conversely, if the specific file is found to be without malicious code, then the corresponding PID is added to the whitelist. Furthermore, this sandboxed-evaluation process is executed on an isolated virtual machine that prevents the malicious code from negatively affecting the PC device or the remote server. The overall method of the present invention continues by executing a threat remediation process for the specific file with the remote server, if the corresponding PID for the specific file is on the blacklist (Step E). The threat remediation process is a sub-process that is used to remove or disable a personal file that is found to contain malicious code.

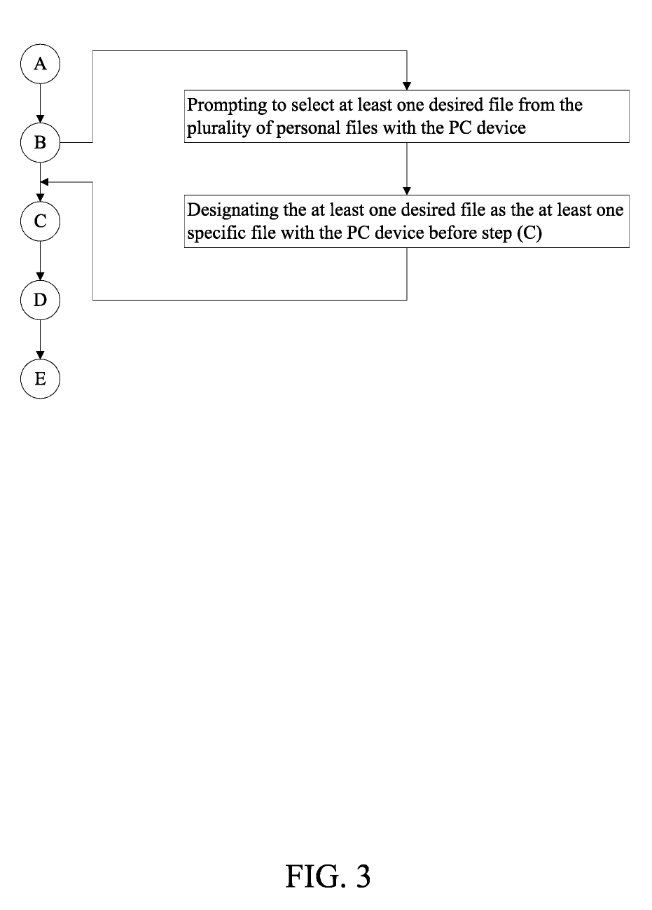

As can be seen in FIG. 3, the present invention is designed to give the user multiple options as to what personal files should be scanned and when the scanning should occur. To that end, the present invention includes a sub-process that enables the user to select at least one file that should be scanned. As such, the sub-process begins by prompting to select at least one desired file from the plurality of personal files with the PC device. The at least one desired file is one or more personal files that the user would like to have scanned for malicious code. The sub-process continues by designating the at least one desired file as the at least one specific file with the PC device before Step C. This step prepares the method of the present invention to scan the desired file for malicious code. Additionally, this sub-process enables the user to manually initiate a malicious code scan on one or more personal files.

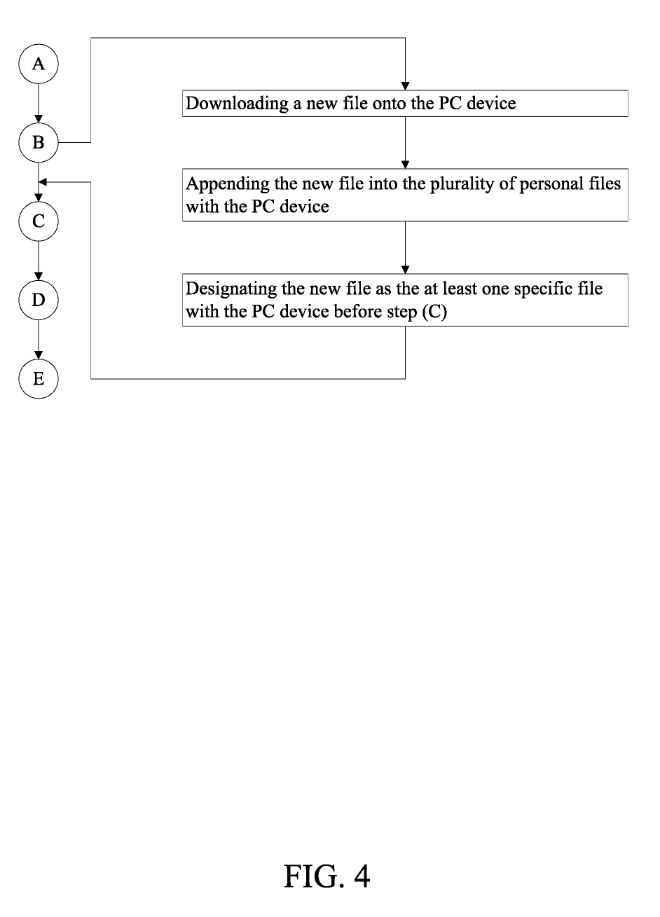

As can be seen in FIG. 4, a separate sub-process of the method of the present invention is used to automatically initiate a scan every time the user downloads a new file. This sub-process begins when the user completes downloading a new file onto the PC device. The sub-process continues by appending the new file into the plurality of personal files with the PC device. Once the user has downloaded the new file, the sub-process is initiated and the new file is added to the plurality of personal files. As such, the new file can be scanned for malicious code. Specifically, the sub-process continues by designating the new file as the at least one specific file with the PC device before Step C. This step prepares the method of the present invention to scan the new file for malicious code.

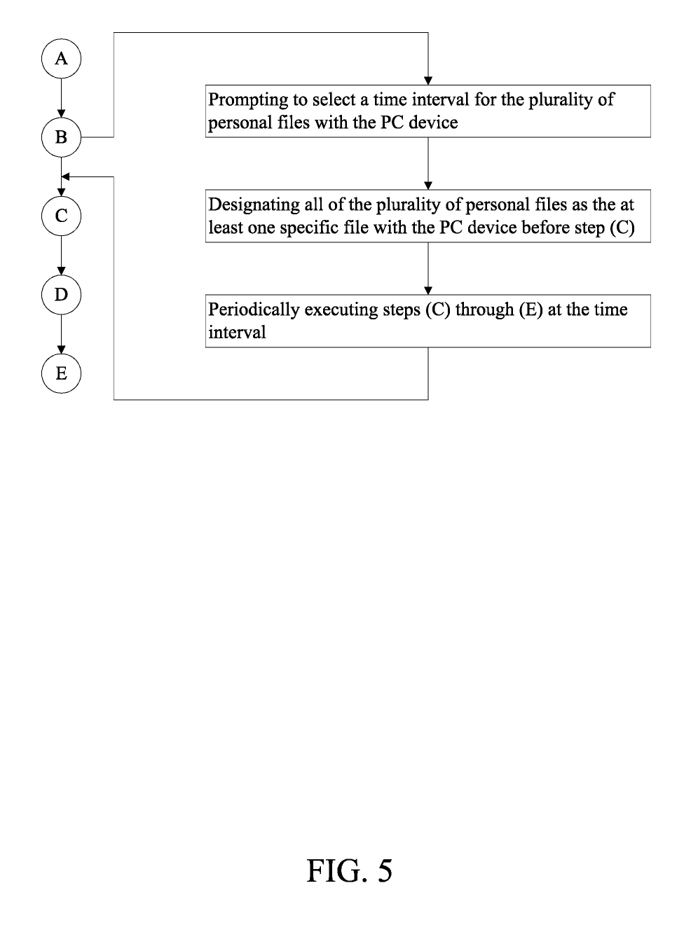

As can be seen in FIG. 5, another separate sub-process of the overall method of the present invention is used to execute periodic scans of the plurality of personal files stored on the user's PC device. To accomplish this the sub-process begins by prompting to select a time interval for the plurality of personal files with the PC device. The time interval is the length of time that will elapse between automated scans of the user's PC device. For example, if the user selects a twelve-hour time interval then the system will execute a scan of the plurality of personal files stored on the user's PC device every twelve hours. Alternatively, the present invention can be used with a preset time interval that the user does not control. The sub-process continues by designating all of the plurality of personal files as the at least one specific file with the PC device before Step C. This directs the method of the present invention to scan all of the personal files that are available on the user's PC device. Finally, the sub-process continues by periodically executing Step C through Step E at the time interval. This step initializes the periodic scan that occurs whenever the time interval has elapsed.

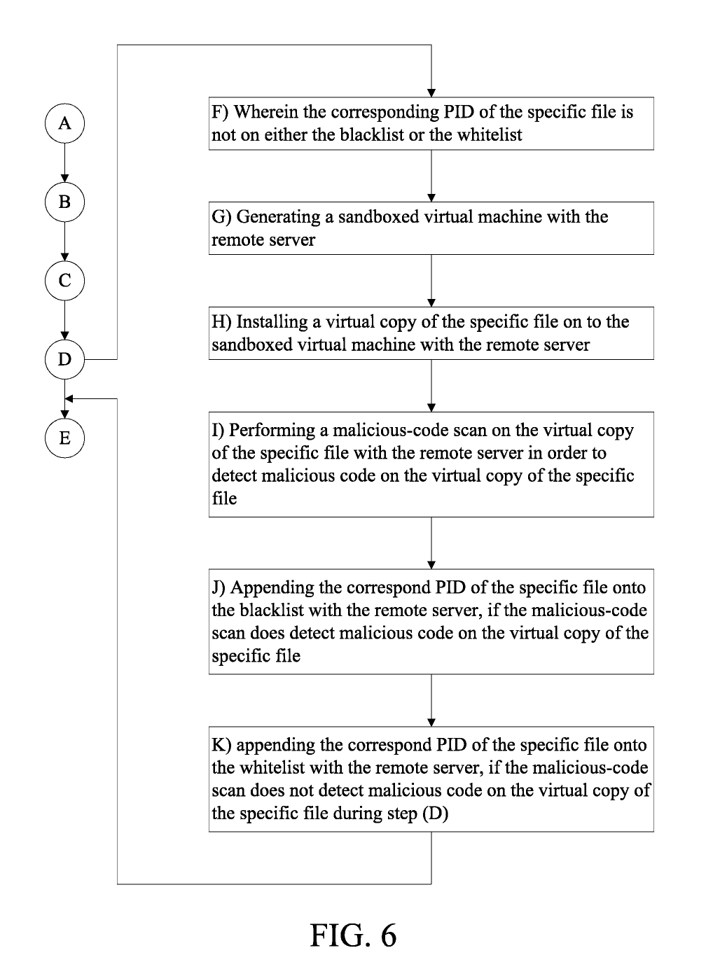

As can be seen in FIG. 6, the present invention is designed with a sub-process that is used to determine if an unrecognized personal file contains malicious code. Additionally, the present invention is designed to perform this characterization in real-time and on demand. This sub-process is initiated when the corresponding PID of the specific file is not on either the blacklist or the whitelist (Step F). If the PID of the specific file is not found in the blacklist or the whitelist, then the method of the present invention designates the specific file as an unrecognized file. The sandboxed-evaluation process is designed to identify malicious code within any unrecognized file. Additionally, the sandboxed-evaluation process can be set to periodically check the programs on the black list and the whitelist for malicious code. This functionality maintains the integrity of the blacklist and the whitelist even as programs are updated. The sub-process continues by generating a sandboxed virtual machine with the remote server (Step G). The sandboxed virtual machine is an isolated virtualized environment that the remote server creates to test the unrecognized file. The sub-process continues by installing a virtual copy of the specific file on to the sandboxed virtual machine with the remote server (Step H). Likewise, the virtual copy is a copy of the unrecognized file that is safely installed onto the sandboxed virtual machine. Once installed the virtual copy can be manipulated by the processes of the remote server without damaging the PC device or the remote server. As such, the sub-process continues by performing a malicious-code scan on the virtual copy of the specific file with the remote server in order to detect malicious code on the virtual copy of the specific file (Step I). The malicious-code scan is a routine that tests the virtual copy to determine if any included code can be classified as malicious. Specifically, the malicious-code scan determines if the specific file that was used to create the virtual copy poses a threat to the user's PC device. Additionally, the malicious code scan determines if the specific file exhibits unauthorized behaviors including, but not limited to, tracking the user's web browsing, reporting personal information, or otherwise impinging on the user's privacy. In this way, the sandboxed-evaluation process protects the user's privacy and personal information. The sub-process continues by appending the correspond PID of the specific file onto the blacklist with the remote server, if the malicious-code scan does detect malicious code on the virtual copy of the specific file (Step J). The sub-process us used to automatically update the blacklist with the PID of the specific file that was found to contain malicious code. Similarly, the sub-process continues by appending the correspond PID of the specific file onto the whitelist with the remote server, if the malicious-code scan does not detect malicious code on the virtual copy of the specific file during Step D (Step K). As a result, the sub-process automatically updates the blacklist and the whitelist with PIDs that were once unknown. In this way, the present invention becomes better at recognizing threats as time goes on.

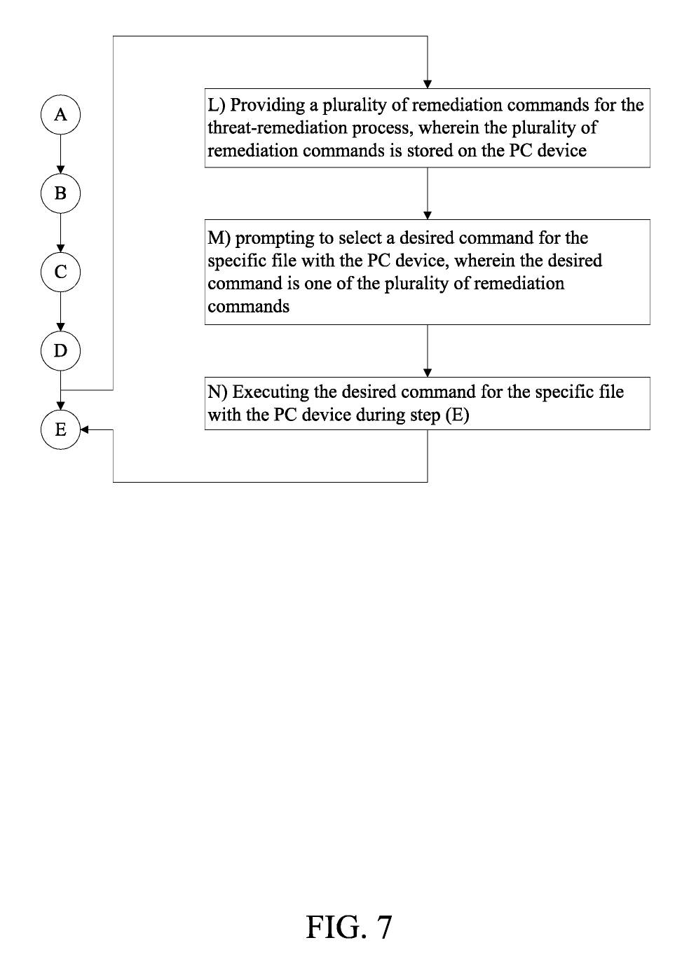

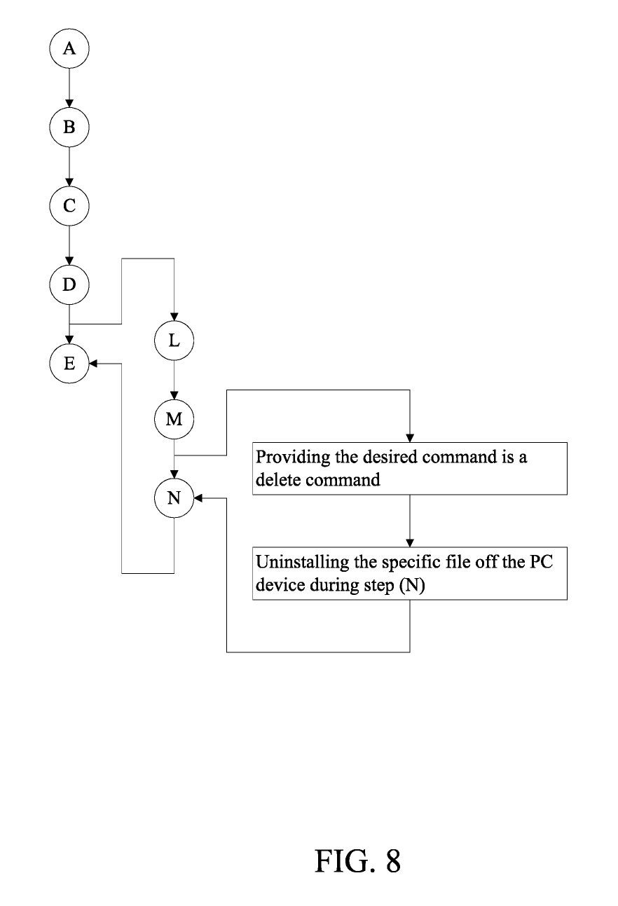

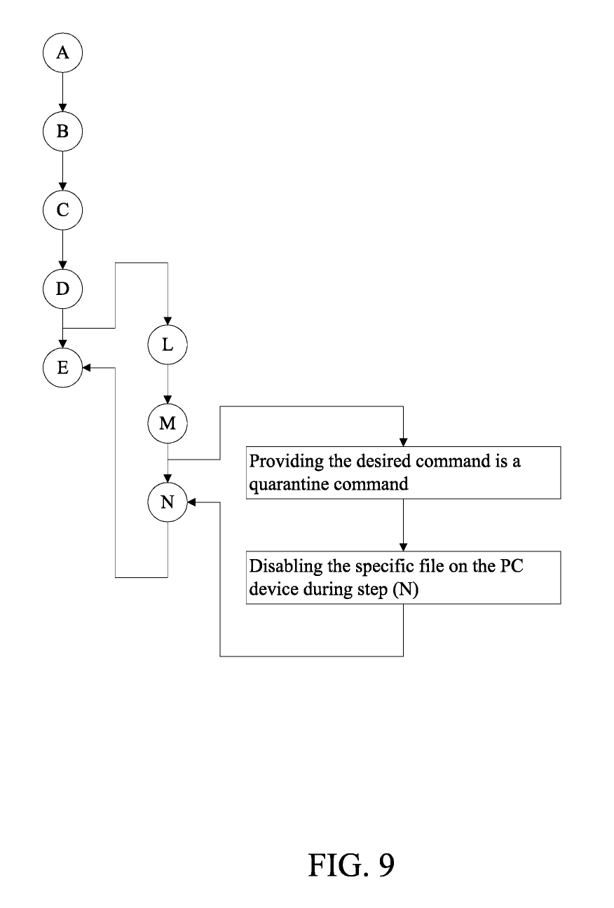

As can be seen in FIG. 7, FIG. 8, and FIG. 9, after the specific file has been compared to the blacklist or run through the sandboxed-evaluation process, the specific file's corresponding PID will wither be on the black list or on the white list. If the specific file's corresponding PID is found on the blacklist, the method of the present invention initiates the threat remediation process. The threat remediation process begins by providing a plurality of remediation commands for the threat-remediation process (Step L). The plurality of remediation commands is a collection of commands that instruct the method of the present invention how deal with malicious pieces of code. Additionally, the plurality of remediation commands is stored on the remote server and transmitted to the PC device once the threat remediation process is initiated. The sub-process continues by prompting to select a desired command for the specific file with the PC device (Step M). The desired command is any one of the plurality of remediation commands that the user would like to execute. This gives the user the choice of how to deal with a personal file that contains malicious code. Once the user has made a selection, the sub-process continues by executing the desired command for the specific file with the PC device during Step E (Step N). The sub-process then performs the user's desired command and the threat remediation is complete. Similarly, the threat remediation process can be automated. That is, the user selects a desired command from the plurality of remediation commands only once. Afterward, all threat remediation processes would automatically implement this remediation command. In one eventuality, the user would like to delete the personal file found to contain malicious code. In this instance, the user selects the desired command as a delete command. Additionally, the threat remediation command can be preset and the user is never given the option to select a desired command. The sub-process then continues by uninstalling the specific file off the PC device during step N. Uninstalling the specific file removes the file from the user's PC device and therefore shields the user from harm. In a second eventuality, the user would like to quarantine the personal file found to contain malicious code. In this instance, the user selects the desired command as a quarantine command. The sub-process then continues by disabling the specific file on the PC device during step N. Disabling the specific file does not remove the file from the user's PC device. However, the specific file is disabled and the user is shielded from harm.

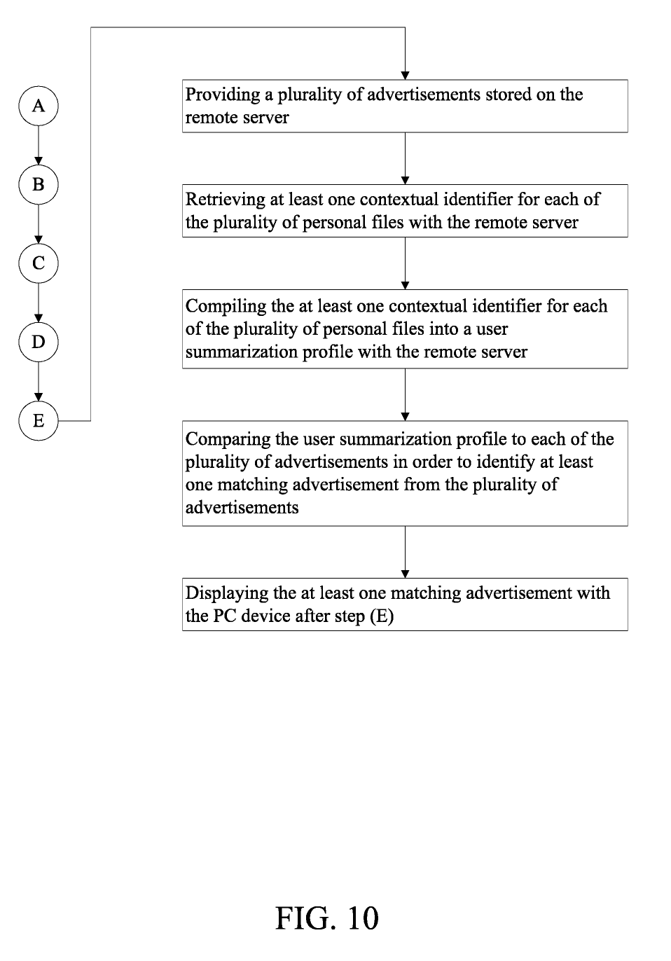

As can be seen in FIG. 10, in addition to identifying malicious code, the present invention is designed to suggest products and services that would benefit the user. To accomplish this, the method of the present invention employs a sub-process for distributing advertisements to the user. The sub-process begins by providing a plurality of advertisements stored on the remote server. The plurality of advertisements is a collection of promotional notifications that include pictures, videos, hyperlinks, and written information about specific products and services. The sub-process continues by retrieving at least one contextual identifier for each of the plurality of personal files with the remote server. The contextual identifier is a piece of metadata that is associated with each of the plurality of personal files. The sub-process continues by compiling the at least one contextual identifier for each of the plurality of personal files into a user summarization profile with the remote server. The summarization profile is created from an analysis of the contextual identifiers that are associated with each of the plurality of personal files. This step turns the disparate pieces of metadata into a profile of the user which reveals what types of products and services would best serve the user. The summarization profile may also include information from the user's web browsing history, and tasks that are frequently performed with the PC device. The sub-process continues by comparing the user summarization profile to each of the plurality of advertisements in order to identify at least one matching advertisement from the plurality of advertisements. The at least one matching advertisement is one or more of the advertisements that are stored in the remote server. The sub-process constructs a virtual profile of the user and then finds advertisements to which the user is most likely to be receptive. The sub-process continues by displaying the at least one matching advertisement with the PC device after Step E. The user is then presented with the matching advertisement in a format that can be easily interacted with. The method of the present invention preferably tracks if the user interacts with the matching advertisement. As a result, the method of the present invention can form longitudinal studies of the user's behavior and improve the summarization profile.

Although the invention has been explained in relation to its preferred embodiment, it is to be understood that many other possible modifications and variations can be made without departing from the spirit and scope of the invention as hereinafter claimed.

What is claimed is:

1. A method for identifying and removing malicious software comprises:
(A) providing a personal computing (PC) device communicably coupled to at least one remote server, wherein the PC device contains a plurality of personal files, and wherein each of the plurality of personal files is associated with a corresponding program identifier (PID);
(B) providing a blacklist and a whitelist that are managed by the remote server;
(C) receiving a scan request for at least one specific file with the PC device, wherein the specific file is from the plurality of personal files;
(D) executing a sandboxed-evaluation process for the specific file with the remote server in order to append the corresponding PID of the specific file to either the blacklist or the whitelist, if the corresponding PID for the specific file is not on either the blacklist or the whitelist; and
(E) executing a threat remediation process for the specific file with the remote server, if the corresponding PID for the specific file is on the blacklist.

2. The method for identifying and removing malicious software as claimed in claim 1 comprises:
prompting to select at least one desired file from the plurality of personal files with the PC device; and
designating the at least one desired file as the at least one specific file with the PC device before step (C).

3. The method for identifying and removing malicious software as claimed in claim 1 comprises:
downloading a new file onto the PC device;
appending the new file into the plurality of personal files with the PC device; and
designating the new file as the at least one specific file with the PC device before step (C).

4. The method for identifying and removing malicious software as claimed in claim 1 comprises:
prompting to select a time interval for the plurality of personal files with the PC device;
designating all of the plurality of personal files as the at least one specific file with the PC device before step (C); and
periodically executing steps (C) through (E) at the time interval.

5. The method for identifying and removing malicious software as claimed in claim 1 comprises:
(F) wherein the corresponding PID of the specific file is not on either the blacklist or the whitelist;
(G) generating a sandboxed virtual machine with the remote server;
(H) installing a virtual copy of the specific file on to the sandboxed virtual machine with the remote server;
(I) performing a malicious-code scan on the virtual copy of the specific file with the remote server in order to detect malicious code on the virtual copy of the specific file;
(J) appending the correspond PID of the specific file onto the blacklist with the remote server, if the malicious-code scan does detect malicious code on the virtual copy of the specific file; and
(K) appending the correspond PID of the specific file onto the whitelist with the remote server, if the malicious-code scan does not detect malicious code on the virtual copy of the specific file during step (D).

6. The method for identifying and removing malicious software as claimed in claim 1 comprises:
(L) providing a plurality of remediation commands for the threat-remediation process, wherein the plurality of remediation commands is stored on the remote server;
(M) prompting to select a desired command for the specific file with the PC device, wherein the desired command is one of the plurality of remediation commands; and
(N) executing the desired command for the specific file with the PC device during step (E).

7. The method for identifying and removing malicious software as claimed in claim 6 comprises:
providing the desired command is a delete command; and
uninstalling the specific file off the PC device during step (N).

8. The method for identifying and removing malicious software as claimed in claim 6 comprises:
providing the desired command is a quarantine command; and
disabling the specific file on the PC device during step (N).

9. The method for identifying and removing malicious software as claimed in claim 1 comprises:
providing a plurality of advertisements stored on the remote server;
retrieving at least one contextual identifier for each of the plurality of personal files with the remote server;
compiling the at least one contextual identifier for each of the plurality of personal files into a user summarization profile with the remote server;
comparing the user summarization profile to each of the plurality of advertisements in order to identify at least one matching advertisement from the plurality of advertisements; and
displaying the at least one matching advertisement with the PC device after step (E).
